(19) United States
(12) Patent Application Publication
(10) Pub. No.: US 2025/0073654 A1
(43) Pub. Date: Mar. 6, 2025

(54) MIXING VESSEL FOR CENTRIFUGAL MIXERS

(71) Applicant: TICKERWORKS, INC., Folsom, CA (US)

(72) Inventor: Ramiro M. PEREZ, Folsom, CA (US)

(21) Appl. No.: 18/817,597

(22) Filed: Aug. 28, 2024

Related U.S. Application Data
(60) Provisional application No. 63/536,358, filed on Sep. 1, 2023.

(51) Int. Cl. B01F 29/00

(52) U.S. Cl. CPC B01F 29/40221

(57) ABSTRACT

A mixing vessel for centrifugal mixers comprises: a container including an open first end and a closed second end, an inner side wall of the container defining a cavity, wherein a blade stems off, at least partially, from the inner side wall of the container, and at least partially from a bottom wall of the container, a portion of the blade from the inner side wall and a portion of the blade from the bottom wall merging with each other, wherein a plurality of guides stem from an exterior side wall of the container, the plurality of guides being arranged at least fifteen (15) degrees apart and extending around the circumference of the exterior side wall of the container; a container-shaped inner liner configured to slide into the cavity of the container and remain in an engaged position during filling and mixing processes; and a removable cap.

### PRIORITY PATENT APPLICATION

This patent application is a non-provisional utility patent application drawing priority from U.S. provisional patent application Ser. No. 63/536,358; filed Sep. 1, 2023. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2022-2024, TICKERWORKS, INC., All Rights Reserved.

### TECHNICAL FIELD

This patent document pertains generally to centrifugal mixers and, more specifically, to a novel mixing vessel designed for the compounding industry. The various example embodiments disclosed herein provide an alternative mixing vessel that incorporates an internal blade and an internal container-shaped inner liner to the standard containers presently used for mixing. Therefore, the present invention aims to overcoming challenges related to particle size reduction, heat dissipation, and mixture inconsistency, while improving homogeneity and speed.

### BACKGROUND

Centrifugal mixers have found widespread application across diverse industries for blending purposes. Notably, they have gained significant prominence in the pharmaceutical compounding industry, particularly for personalized medications. This is attributed to their capacity to mix pharmaceutical ingredients within containers at precise and controlled speeds, without the need for impellers that can inadvertently introduce excessive air and heat into the mixture. These mixers typically comprise receptacles designed to accommodate specific containers and adapters for other specialized devices, boasting cylindrical and hollow inner chambers that facilitate seamless rotation with minimal friction and heat dissipation.

### BRIEF DESCRIPTION OF THE DRAWINGS

The various embodiments are illustrated by way of example, and not by way of limitation, in the figures of the accompanying drawings in which:

FIG. 1 illustrates an exploded view showing the structural components of an example embodiment of a mixing vessel, comprising a container, a container-shaped inner liner, and a cap, illustrating the fitment of these components relative to one another;

FIG. 2 shows an exploded view, in one embodiment, depicting the structural elements of a container with an inner blade, a container-shaped inner liner with a blade, and a threaded cap;

FIG. 3 illustrates a side view of the container-shaped inner liner fitting within the cavity of the container;

FIG. 4 illustrates a perspective view of an example embodiment of the container of a mixing vessel with a cap attached via threads;

FIG. 5 illustrates an embodiment featuring a perspective side profile view of a translucent threaded cap attached to the container;

FIG. 6 depicts a perspective view of an example embodiment of a mixing vessel comprising a transparent container with the container-shaped inner liner positioned inside the container in an engaged position;

FIG. 7 illustrates a perspective view of an example embodiment of a mixing vessel showing the interior cavity of the container-shaped inner liner with the cap removed;

FIG. 8 illustrates a perspective view of an example embodiment of a mixing vessel showing the interior cavity of the container with the cap removed;

FIG. 9 illustrates a cross-section showing all the components of a mixing vessel of an example embodiment, including a threaded cap, a container, and a vessel inner liner with an internal vertical blade, a triangular blade, and horizontal blade;

FIG. 10 illustrates a cross-section of the mixing vessel, demonstrating how the vertical blades of the inner liner complement the vertical blade of container;

FIG. 11 illustrates a cross-section of a container with a vertical blade and a horizontal blade extending from the inner side wall and inner bottom wall of the container and a threaded cap in an engaged position;

FIG. 12 illustrates a translucent perspective view of the container-shaped inner liner, highlighting the extruded vertical blade, the extruded triangular blade, and the extruded horizontal blade;

FIG. 13 depicts a perspective view of the fitment of the cap over a container-shaped inner liner; and

FIG. 14 illustrates a flow diagram showing an example embodiment of a method implemented as described herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

### Advantages and Challenges

Centrifugal mixers offer several advantages in the realm of blending, making them well-suited for various applications, including pharmaceutical formulations. These mixers boast overall quicker mixing times for specific preparations, minimizing heat transfer to the products, especially during low-speed operations, and reducing the introduction of air into the mixture, resulting in deaired and homogeneous blends. However, certain challenges persist, such as extended mixing times, difficulties in achieving complete homogeneity, limitations in effective particle size reduction, issues with blending low viscosity lotions or suspensions, and excessive mixing times needed for certain blends. Overcoming these challenges is essential for optimizing the efficiency and effectiveness of centrifugal mixers in the pharmaceutical industry.

### The Need for Efficient Mixing Vessels

The increasing demand for personalized medications in compounding pharmacies highlights the importance of efficient and timely preparation methods. To overcome the limitations of conventional mixing containers, there is a clear requirement for an innovative mixing vessel that can significantly reduce mixing time, enhance mixture homogeneity, and improve particle size reduction in pharmaceutical formulations. The current market lacks mixing vessels constructed with materials tailored to handle various mixtures effectively and without inadvertently expanding the base due to the introduction of air pockets. Furthermore, there is a noticeable absence of mixing technologies specifically designed to expedite particle size reduction or accelerate the temperature increase for certain preparations when desired. Meeting these needs calls for the development of an advanced mixing vessel, one that addresses these specific requirements and revolutionizes the compounding process in the pharmaceutical industry.

### Challenges with Powdery Mixtures

When working with powdery compound mixtures in a centrifugal mixture, there is a potential concern of the mixture becoming overly compacted and tightly adhered to the container walls. This phenomenon not only impacts the consistency of the mixture, but also leads to undesirable adhesion within the inner walls of standard containers. Maintaining the powdery mixture inside a mixing vessel in a loose state that retains its effectiveness in pharmaceutical applications poses a significant challenge. To address this challenge, the incorporation of inner blades inside a container proves to be highly effective. These blades actively disrupt the compacted mixture and discourage the adhesion of the products being mixed to the container walls, ensuring a more consistent and efficient blending process. Additionally, incorporating a method to enhance shear force within the mixing vessel is crucial for reducing particle size and achieving quicker temperature increases with minimal mixing time and speed.

### The Role in Compounding Pharmacies

As population growth accelerates, coupled with rising drug shortages and heightened awareness of modern health trends, the demand for personalized medications from compounding pharmacies is increasing, making efficient and timely preparation methods more essential than ever. The diverse requirements for various dosage forms, including magic mouth suspensions for oral ulcers, ointments for rectal fissures, HRT creams and gels for hormone imbalances, powdery stock concentrations of thyroid hormones (T3 and T4) for hormone imbalances, flowable molten mixtures for troches, suppositories, and even lollipops, highlight the need for versatile mixing equipment and accessories. In this context, centrifugal mixers play a pivotal role by meeting this demand, allowing compounding pharmacies to prepare a multitude of medications within a limited timeframe and with restricted resources like space, staffing, and finances.

Moreover, having a mixing vessel that further reduces particle size and accelerates the melting of solidified troche or suppository bases while minimizing transfers between jars would be a significant advantage for compounding pharmacies. This combination of efficient mixing and vessel design enhances the overall productivity and effectiveness of the compounding process, benefiting both the pharmacy and its patients.

### Innovative Mixing Vessel Design

The various example embodiments disclosed herein support the need for better end-product homogeneity, faster melting, and improved particle size reduction in pharmaceutical formulations, particularly with flowable custom preparations, by employing a novel mixing vessel designed to overcome these challenges. This innovative mixing vessel features a container with a chamber securely held within a centrifugal mixer using external guides. The container can be constructed from various raw materials, such as polypropylene, HDPE, LDPE, elastomers, and other similar materials, to accommodate specific compounding needs.

The mixing vessel features a removable cap constructed similarly to the container, designed to securely close and contain the products being mixed. Additionally, a removable inner liner, which can be made of stainless steel, aluminum, brass, or other materials similar to the mixing container, is designed to fit inside the container. Both the container and the container-shaped inner liner have a cavity that houses a blade positioned in both the vertical and horizontal planes, specifically designed to effectively reduce particle size and enhance the mixing process. The blade extends from the upper side wall and continues downward to connect with a blade extending from the inner bottom wall of the container and inner liner.

### Functions and Benefits of the Blade

The blade in the mixing vessel serves two essential functions. Firstly, it creates higher friction between the vessel and the ingredients being blended. As a result, during asymmetric rotation, the temperature inside increases at a faster rate compared to standard bladeless containers. Consequently, the blade significantly shortens the time required to reach the desired temperature, critical for melting certain bases. Secondly, the presence of the blade provides another advantage. As the material undergoes asymmetric rotation, the shear force of the blade, especially at higher speeds, triturates the mixture, effectively reducing particle size and breaking down clumps or agglomerates of various pharmaceutical components.

### Material Considerations and Beneficial Design

When using centrifugal mixers and mixing vessels, it is crucial to address the temperature rise inside the chamber due to asymmetric rotation. Therefore, with some substances, the construction of the mixing vessel must use materials capable of withstanding elevated temperatures. The container-shaped inner liner provides flexibility, allowing it to be made from various materials like steel, aluminum, copper, and other high-temperature resilient metals. This ensures effective mixing of different compounds with varying internal temperature requirements.

While a full construction of the mixing vessel with steel, copper, or aluminum seems advantageous for accommodating compounds with different temperature needs, it comes with the drawback of increased weight. Given the weight capacity limitations of centrifugal mixers, an all-metal construction for the entire vessel is not ideal. Instead, a more optimal design solution involves primarily using plastic or elastomeric resins for the vessel to keep its weight low. The inner liner can then be crafted from a very thin metal to maintain overall container weight at a minimum.

Furthermore, incorporating an internal blade is essential for efficiently reducing particle size and increasing friction at a significantly faster rate. This well-balanced mixing vessel design caters effectively to mixtures that require these specific characteristics. By carefully considering the right materials, weight distribution, and functionality, this innovative approach ensures exceptional mixing performance, meeting the diverse requirements of various applications.

The external lock and key mechanism of the jar during mixing is achieved by using a circular array of evenly spaced tabs along the outer wall of the mixing vessel. These tabs help to securely position the mixing vessel within the hollow opening of the mixer's receptacle. The multiple protruding tabs on the mixing vessel engage with the locking features of the mixer receptacle, allowing the mixer to fully control the axial rotation and precise positioning of the mixing vessel.

The interaction between the container, cap, and container-shaped inner liner is crucial for achieving particle reduction, improved homogeneity, enhanced melting time, and preventing overly compressed powdery mixtures. Given that there is a blade in both the container and the inner liner, the precise positioning of these components is essential to ensure they fit together properly during the assembly of the mixing vessel. A key feature of the example embodiments is the inclusion of a triangular guide near the bottom portion of the inner liner, which aligns with a corresponding triangular section of the blade that extends from the inner walls of the liner. The vertical and horizontal portions of the blade also act as guides along the exterior side of the inner liner, enabling the container to fit easily over the inner liner's exterior surface.

The various example embodiments disclosed herein provide an alternative mixing vessel that incorporates an internal blade and an internal container-shaped inner liner to the standard containers presently used for mixing. The various example embodiments are described in detail below in connection with the figures provided herewith.

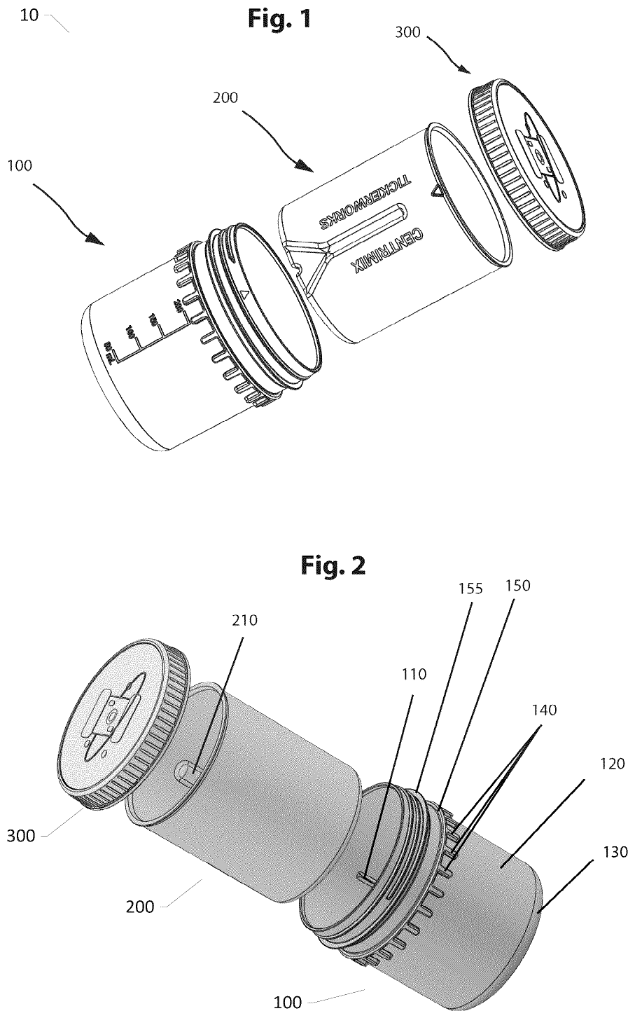

FIG. 1 illustrates an exploded view showing the structural components of a mixing vessel 10, comprising a container 100, a container-shaped inner liner 200, and a cap 300, illustrating the fitment of these components relative to one another.

FIG. 2 shows an exploded view, in one embodiment, depicting the structural elements of a container 100 with an inner blade 110, a container-shaped inner liner 200 with a blade 210, and a threaded cap 300, highlighting the fitment of these components relative to one another. The vessel inner liner 200 features a vertical blade 210 that complements the container 100 vertical blade 110.

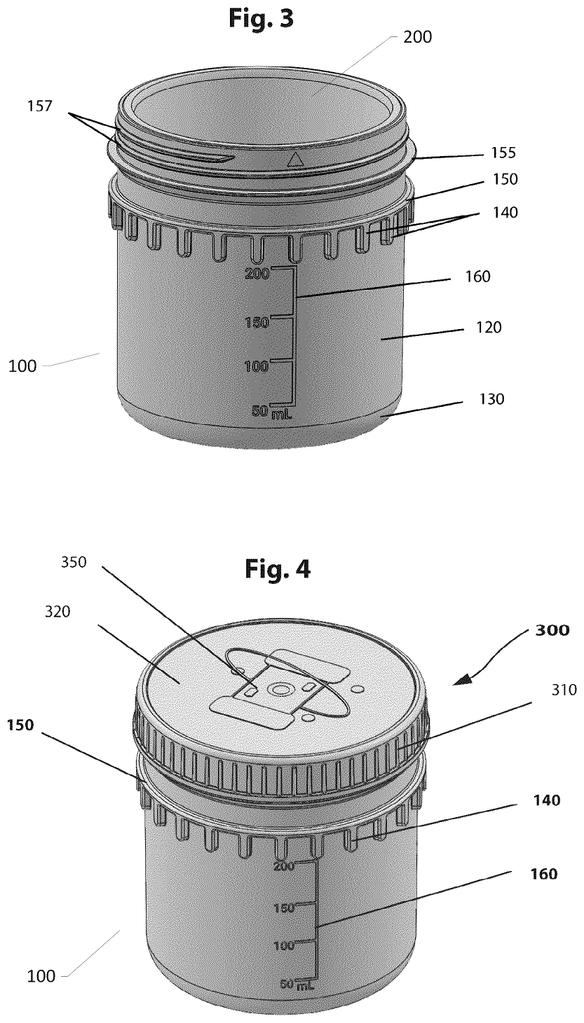

FIG. 3 illustrates a side view of the container-shaped inner liner 200 fitting within a cavity of the container 100. The figure also illustrates a threaded area 157 at the upper end of the container 100, extending from the outer side wall 120, which is designed to engage with the threaded cap 300. Below the threaded section, there is an upper ledge 155 and a lower ledge 150, where a series or plurality of guides 140 are evenly spaced around the circumference of the container 100's outer wall, extending downwards toward the closed end of the container 100.

FIG. 4 illustrates a perspective view of the container 100 of a mixing vessel 10 with a cap 300 attached via threads 157. The guides 140, projecting from the outer wall of the container 100, extend downwards from the lower ledge 150 towards the closed end of the container 100. A graduation area 160 indicates the amount of product placed inside the container 100.

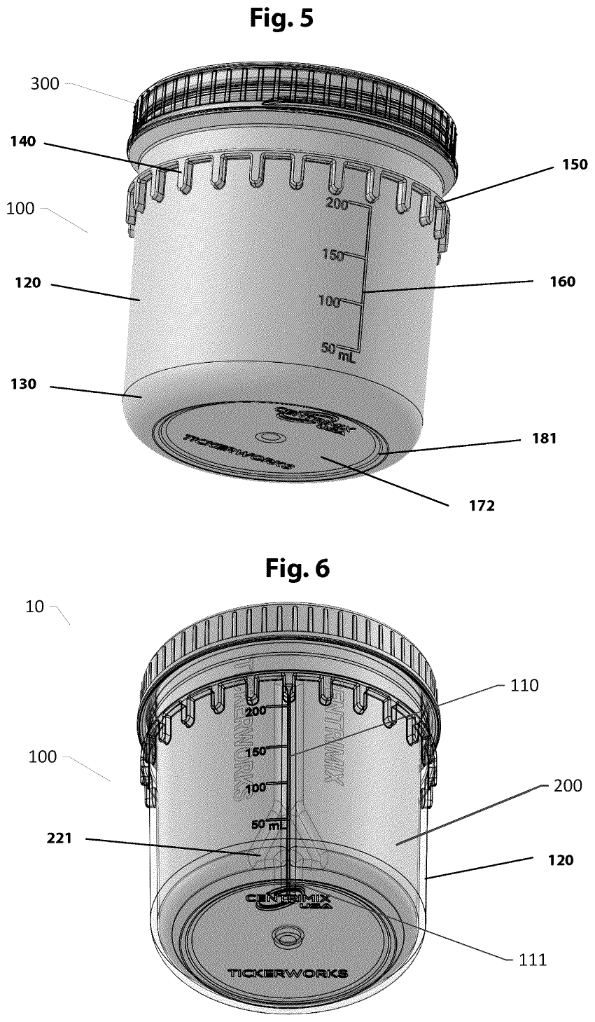

FIG. 5 illustrates an embodiment featuring a perspective side profile view of a translucent threaded cap 300 attached to the container 100. The heel of the outer wall 130, and the heel of the inner wall 131 of the container 100 helps prevent chemicals or substances from becoming trapped in the corners between these walls. Additionally, the outer bottom wall 172 is slightly raised above the feet 181 of the container 100, providing stability when the container is placed on various surfaces.

FIG. 6 depicts a perspective view of a mixing vessel 10 comprising a transparent container 100 with the container-shaped inner liner 200 positioned inside the container 100 in an engaged position. The recessed triangular portion of the blade outer wall 221 of the container-shaped inner liner 200 is shown, complementing the container 100 horizontal blade 111 and vertical blade 110. The extruded blades 110 and 111 of the container 100 prevent axial rotation of the vessel inner liner 200.

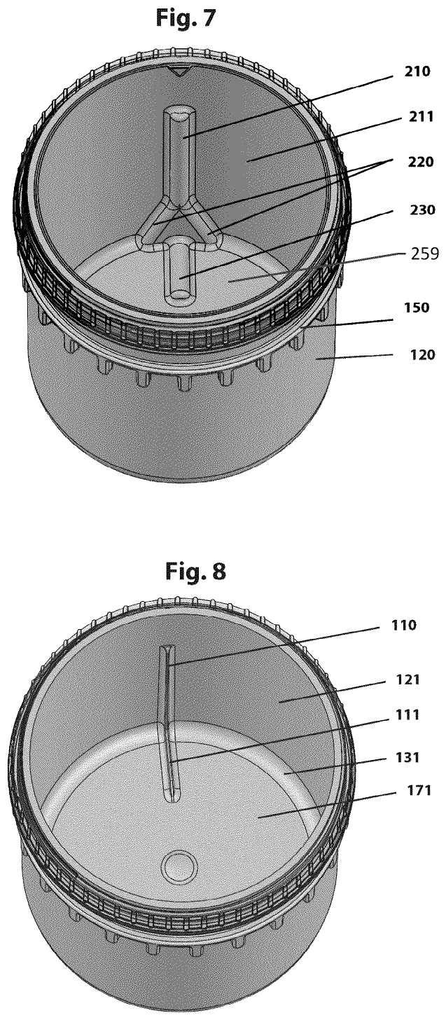

FIG. 7 illustrates a perspective view of an example embodiment of a mixing vessel 10, showing the interior cavity of the container-shaped inner liner 200 with the cap 300 removed. The vertical blade 210 and triangular blade portion 220 of the container-shaped inner liner 200, along with the horizontal blade portion 230, are shown extending from the inner side wall 211 and the inner bottom wall 259 of the liner. In this embodiment, the vessel inner liner is fabricated by stamping stainless steel, aluminum, or other metals, providing stronger shear force for particle reduction during mixing. The extruded portions of the container-shaped inner liner 200 are recessed on the opposite side due to this type of technological construction.

FIG. 8 illustrates a perspective view of an example embodiment of a mixing vessel 10 showing the interior cavity of the container 100 with the cap 300 removed. The image highlights the vertical blade 110 and horizontal blade 111 of the container 100, with the upper portion of the cap 300 removed.

FIG. 9 illustrates a cross-section showing all the components of a mixing vessel 10, including a threaded cap 300, a container 100, and a vessel inner liner 200 with an internal vertical blade 210, a triangular blade 220, and horizontal blade 230. Also shown are the upper ledge 155, the lower ledge 150, and guides 140 stemming from the lower ledge 150 and pointing down to the second end of the container 100.

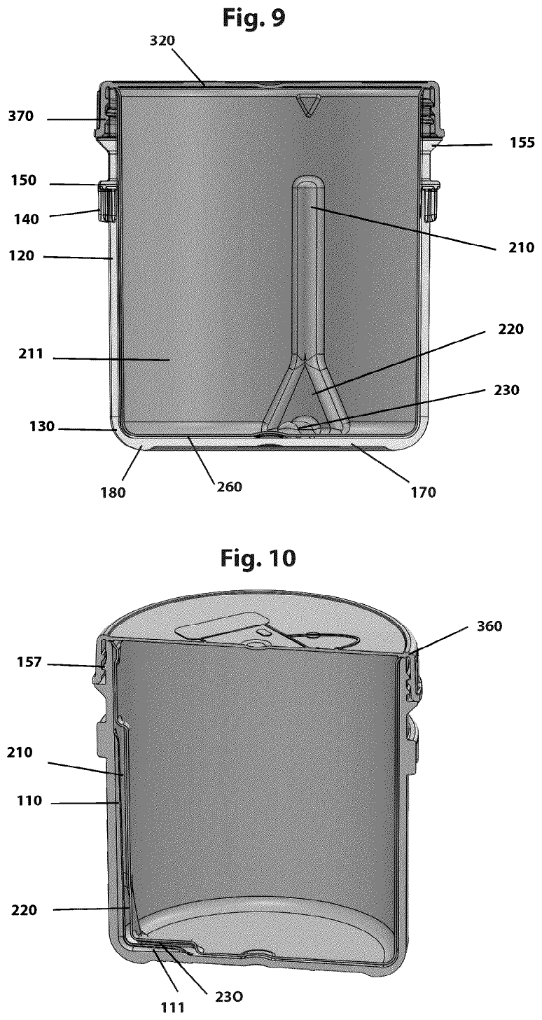

FIG. 10 illustrates a cross-section of the mixing vessel 10, demonstrating how the vertical blade 210 of the inner liner 200 complement the vertical blade 110 of container 100, and likewise, the horizontal blade 230 of inner liner 200 complement the horizontal blade 111 of container 100.

FIG. 11 illustrates a cross-section of a container 100 with a vertical blade 110 and a horizontal blade 111 extending from the inner side wall 121 and inner bottom wall 171 of the container 100 and a threaded cap 300 in the engaged position.

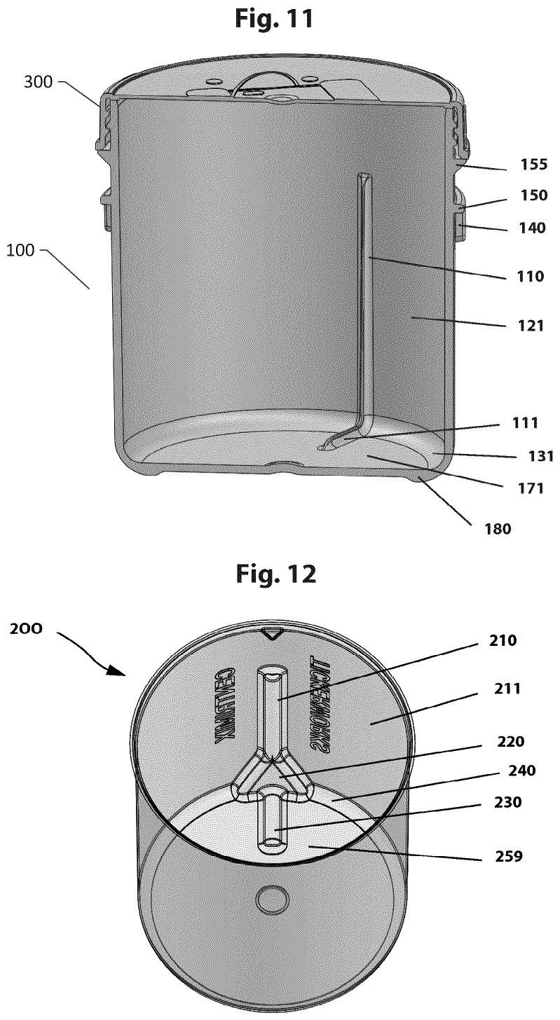

FIG. 12 illustrates a translucent perspective view of the container-shaped inner liner 200, highlighting the extruded vertical blade 210, the extruded triangular blade 220, and the extruded horizontal blade 230, all extending from the inner walls 211 and 259 of the vessel inner liner 200.

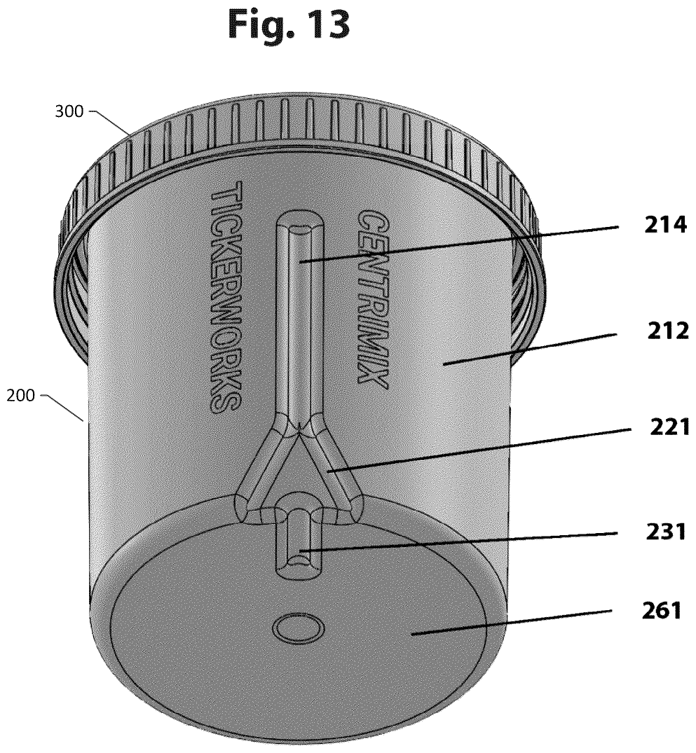

FIG. 13 depicts a perspective view of the fitment of the cap 300 over a container-shaped inner liner 200. In this embodiment, the outer wall 212 of the container-shaped inner liner 200 is exposed, along with the exterior surface of the bottom wall 261. The outer walls of the vertical blade 214, the triangular blade 221, and the horizontal blade 231 are also visible and recessed.

Various example embodiments are described in detail herein in connection with the specific elements employed for each example embodiment. Various example embodiments are detailed below.

A mixing vessel comprising: a container including an open first end and a closed second end, an inner side wall of the container defining a cavity, wherein a blade stems off, at least partially, from the inner side wall of the container, and at least partially from a bottom wall of the container, a portion of the blade from the inner side wall and a portion of the blade from the bottom wall merging with each other, wherein a plurality of guides stem from an exterior side wall of the container, the plurality of guides being arranged at least fifteen (15) degrees apart and extending around the circumference of the exterior side wall of the container; a container-shaped inner liner configured to slide into the cavity of the container and remain in an engaged position during filling and mixing processes; and a removable cap configured to close the open first end of the container.

The mixing vessel as disclosed above, wherein the inner wall of the container-shaped inner liner has a diameter less than the inner wall of the container of the mixing vessel.

The mixing vessel as disclosed above; wherein the filling process involves adding active and inactive pharmaceutical ingredients, bases, binders, carriers, or other substances into the container-shaped inner liner; and wherein; the mixing process involves placing the mixing vessel and its contents into a mixer and subjecting it to mixing using new or predetermined mixing parameters.

The mixing vessel as disclosed above; wherein when the container-shaped inner liner is absent, the filling process involves adding active and inactive pharmaceutical ingredients, bases, binders, carriers, or other substances directly into the container; and wherein; the mixing process involves placing the capped container and its contents into a mixer and subjecting it to mixing using new or predetermined mixing parameters.

The mixing vessel as disclosed above, wherein the outer guides engage with a mixer's receptacle in order for the mixer, through its receptacle, to control a variety of sequential or simultaneous motions specified to produce optimal mixtures of the contents within the mixing vessel.

The mixing vessel as disclosed above, wherein the container-shaped inner liner may rotate axially with respect to the container in a disengaged position; conversely, when the inner liner is in an engaged position within the container, the container hinders axial movement of the inner liner.

The mixing vessel as disclosed above, wherein the external guides on the outer side wall of the container engage with a mixer's receptacle locking guides, positioned at intervals of 15 degrees, 24 degrees, 30 degrees, 36 degrees, 40 degrees, 45 degrees, 60 degrees, 72 degrees, 90 degrees, 120 degrees, 180 degrees, or other intervals.

The mixing vessel as disclosed above, wherein a lower ledge includes a circular rim surrounding the outer side wall of the container, with interlocking guides extending downward toward the closed end, wherein these guides engage with a mixer's receptacle to control the position of the jar and ensure precise movement of the mixing vessel.

The mixing vessel as disclosed above, wherein the container's blade guides the inner liner into its correct position by engaging with a triangular portion of a recessed blade of the outer wall of the inner liner.

The mixing vessel as disclosed above, wherein the blade of the inner liner includes a vertical portion, a triangular portion, and a horizontal portion, wherein the blade extends from the inner wall of the inner liner and is recessed on the outer wall of the inner liner.

A method for preparing gel, cream, ointment, or powdery compound mixtures within a centrifugal mixer's mixing vessel, the method comprising: a) aligning and sliding the recessed external wall of the container-shaped inner liner over the inner wall of a container configured with at least one blade, such that the container restricts axial rotation of the inner liner when in an engaged position, and the blades on both the container and inner liner are complementary, allowing the inner liner to slide smoothly into the container's cavity, where it remains in an engaged position during the filling and mixing processes; b) placing active and inactive ingredients into the cavity of a container-shaped inner liner equipped with an internal blade; c) attaching a cap to the first end of the container; d) inducing asymmetric mixing by selecting from a formulary of predetermined mixing parameters or establishing new parameters for the constituents within the mixing vessel; and e) removing the mixing vessel from the mixer, and affixing at least one label or marking to the exterior of the mixing vessel in accordance with the prescriber's instructions, then either dispensing it to an individual or transferring its contents to another container or a metered dose dispenser.

A method for preparing gel, cream, ointment, or powdery compound mixtures within a centrifugal mixer's mixing vessel, the method comprising: a) placing both active and inactive ingredients into the mixing vessel, which consists of a container with a first open end and a second closed end, featuring an internal blade that extends at least partially from the inner side wall and the bottom inner wall of the container, with the blades from the inner side wall and bottom wall converging into one another; b) placing a cap over the first end of the mixing vessel to facilitate asymmetric mixing; c) subjecting the mixing vessel and its contents to asymmetric mixing, following established industry-standard mixing parameters, or creating new mixing parameters; d) removing the mixing vessel from the mixer; and e) affixing a label and further packaging for dispensing to end-users, or alternatively, transferring the mixture to another container or metered dose dispenser.

A method for mixing gummies, troche, or suppository polyethylene glycol (PEG) and fatty acid bases used for compounding custom formulations targeting various ailments through oral, buccal, or vaginal sub-mucosal administration within a centrifugal mixer's mixing vessel, the method comprising: a) aligning and sliding the external wall of the inner liner over the inner wall of a container that also incorporates a blade, wherein the blades of both the container and the inner liner are complementary, allowing the inner liner to be smoothly inserted into the container's cavity, where it remains in an engaged position during the filling and mixing processes, and wherein the alignment of the container's internal blade with the recessed area of the inner liner's blade restricts the axial rotation of the inner liner; b) introducing gum base, troche or suppository PEG (polyethylene glycol), fatty acid (oleaginous) base, or a similar composition into the cavity of the container-shaped inner liner equipped with an internal blade; c) placing a cap over the first end of the mixing vessel to contain all constituents; d) subjecting the mixing vessel and its contents to asymmetric mixing, following established industry-standard mixing parameters or creating new parameters, wherein during this phase, the composition of the troche or suppository PEG or fatty acid base may transition from solid to liquid, influenced by the mixing time and the speed of asymmetric mixing; e) removing the mixing vessel from the mixer after a specified time or once the content becomes flowable; f) incorporating additional ingredients into the flowable base if necessary, and then recapping the mixing vessel; g) subjecting the mixing vessel to further asymmetric mixing if needed; h) detaching the mixing vessel from the mixer and transferring the flowable mixture to a suppository or troche mold tray, or another forming tray, wherein the mixture is uniformly distributed across multiple identical volume cavities and allowed to cool, forming solidified troches, suppositories, or gummies; and i) labeling, packaging, and dispensing the solidified troches, suppositories, or gummies to end users.

A method for blending powdered ingredients, including thyroid substances (T3 and T4), progesterone, and other pharmaceutical compounds used to create patient-specific medications for various ailments, aimed at producing powdered stock concentrations or as a precursor to encapsulating compounded powder blends within a centrifugal mixer's mixing vessel, the method comprising: a) aligning and sliding the external wall of the inner liner over the inner wall of a container that also incorporates a blade, wherein the blades of both the container and the inner liner are complementary, allowing the inner liner to be smoothly inserted into the container's cavity, where it remains in an engaged position during the filling and mixing processes, and wherein the alignment of the container's internal blade with the recessed area of the inner liner's blade restricts the axial rotation of the inner liner; b) introducing active and inactive ingredients, along with fillers and excipients, into the cavity of a container-shaped inner liner equipped with an internal blade; c) placing a cap over the first end of the container to securely contain all ingredients; d) subjecting the mixing vessel to asymmetrical blending, using industry-standard mixing settings tailored to the desired product, quantity, and other relevant criteria; e) removing the mixing vessel from the mixer, taking off the cap, and thoroughly inspecting the mixture using a spatula, rod, or similar lab tool, dislodging any densely packed or compressed material and any remnants clinging to the vessel's inner walls, if necessary; f) repeating the asymmetrical blending process for additional mixing cycles if needed, using similar or adjusted mixing parameters; g) detaching the mixing vessel from the mixer and transferring the blended mixture to a capsule machine for encapsulation or to another container or tray; and h) properly packaging and labeling the encapsulated mixture, storing the powdered mixture or transferring it for further processing.

A mixing vessel comprising: a container including an open first end and a closed second end, an inner side wall of the container defining a cavity, wherein a blade stems off, at least partially, from the inner side wall of the container, and at least partially from a bottom wall of the container, a portion of the blade from the inner side wall and a portion of the blade from the bottom wall merging with each other, wherein a plurality of guides stem from an exterior side wall of the container, the plurality of guides being arranged at least fifteen (15) degrees apart and extending around the circumference of the exterior side wall of the container; and a removable cap configured to close the open first end of the container.

The mixing vessel as disclosed above, wherein the plurality of guides are bounded by a rim that encompasses the exterior side wall of the container between the first and second ends of the container.

The mixing vessel as disclosed above, wherein the container is configured in a volume capacity from a group consisting of: 100 milliliters (mLs), 300 mLs, 500 mLs, 600 mLs, 1000 mLs, 1500 mLs, 2000 mLs, 5000 mLs, and 10,000 mLs, or other volumes, thereby accommodating a wide range of mixing requirements across different applications.

The mixing vessel as disclosed above, wherein the container is configured with an aspect ratio from a group consisting of: 1.165:1, with a potential range spanning from 0.5:1 to 2:1.

In the mixing vessel as disclosed above, during the vessel's placement within a mixer, the mixing vessel remains stationary with respect to the receptacle of the mixer, the inner liner, when present, remains stationary relative to the container of the mixing vessel, and the substances contained within the mixing vessel possess the freedom to undergo rotational and orbital movement, facilitating the creation of a uniform final blend, wherein the mixing vessel's blades contribute to decreasing particle size and mitigating the adherence of contents to the vessel walls.

The mixing vessel as disclosed above, wherein the plurality of guides extending from the exterior wall of the container, arranged at least 15 degrees apart from one another, are bounded by a rim that encompasses the outer wall of the container between the first and second ends of the container, and wherein the guides engage with locking elements of a cup-like receptacle on a mixer, securing the mixing vessel in a fixed position relative to the mixer's receptacle during the mixing process, such that the mixing vessel coordinates its movements with those of the mixer's receptacle.

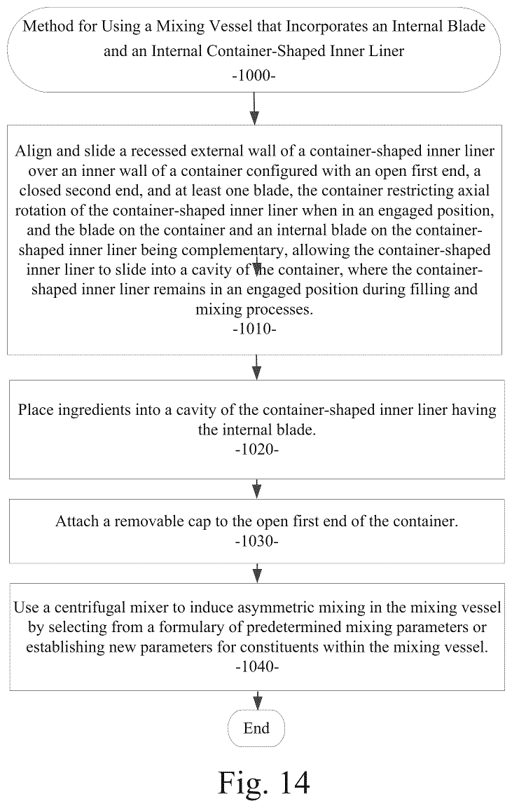

Referring now to FIG. 14, a flow diagram illustrates an example embodiment of a method implemented as described herein. The method 1000 of an example embodiment includes: aligning and sliding a recessed external wall of a container-shaped inner liner over an inner wall of a container configured with an open first end, a closed second end, and at least one blade, the container restricting axial rotation of the container-shaped inner liner when in an engaged position, and the blade on the container and an internal blade on the container-shaped inner liner being complementary, allowing the container-shaped inner liner to slide into a cavity of the container, where the container-shaped inner liner remains in an engaged position during filling and mixing processes (block 1010); placing ingredients into a cavity of the container-shaped inner liner having the internal blade (block 1020); attaching a removable cap to the open first end of the container (block 1030); and using a centrifugal mixer to induce asymmetric mixing in the mixing vessel by selecting from a formulary of predetermined mixing parameters or establishing new parameters for constituents within the mixing vessel (block 1040).

The disclosed mixing vessel offers effective solutions for improved particle size reduction in specific pharmaceutical formulations, faster mixing times, and quicker melting of certain solid bases. It is user-friendly and accommodates a broader range of compounds and raw materials. The innovative features, such as the friction-enhancing blade and versatile inner liner, ensure consistent homogeneity and reproducibility of pharmaceutical formulations, making it an essential tool for compounding pharmacists. Additionally, the lock-and-key engagement between the mixer's receptacle and the external circular array of evenly spaced tabs on the mixing vessel ensures precise orientation and complete control of the vessel's axial movement.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, example embodiments relate to centrifugal mixers and, more specifically, to a novel mixing vessel designed for the compounding industry. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A mixing vessel comprising:
a container including an open first end and a closed second end, an inner side wall of the container defining a cavity, wherein a blade stems off, at least partially, from the inner side wall of the container, and at least partially from a bottom wall of the container, a portion of the blade from the inner side wall and a portion of the blade from the bottom wall merging with each other, wherein a plurality of guides stem from an exterior side wall of the container, the plurality of guides being arranged at least fifteen (15) degrees apart and extending around the circumference of the exterior side wall of the container;
a container-shaped inner liner configured to slide into the cavity of the container and remain in an engaged position during filling and mixing processes; and
a removable cap configured to close the open first end of the container.

2. The mixing vessel of claim 1, wherein an inner wall of the container-shaped inner liner has a diameter less than the inner side wall of the container.

3. The mixing vessel of claim 1, wherein the plurality of guides are configured to engage with a mixer's receptacle in order for the mixer, through its receptacle, to control a variety of sequential or simultaneous motions specified to produce various mixtures of contents within the mixing vessel.

4. The mixing vessel of claim 1, wherein the container-shaped inner liner is configured to, when in a disengaged position, rotate axially with respect to the container, the container-shaped inner liner is further configured to, when in an engaged position, resist rotation axially with respect to the container.

5. The mixing vessel of claim 1, wherein the plurality of guides are configured to engage with a mixer's receptacle locking guides positioned at intervals of 15 degrees, 24 degrees, 30 degrees, 36 degrees, 40 degrees, 45 degrees, 60 degrees, 72 degrees, 90 degrees, 120 degrees, or 180 degrees.

6. The mixing vessel of claim 1, wherein the container further includes a lower ledge on a circular rim surrounding the exterior side wall of the container, with the plurality of guides extending downward toward the closed second end, wherein the plurality of guides are configured to engage with a mixer's receptacle locking guides to control a position of the container-shaped inner liner and ensure precise movement of the mixing vessel.

7. The mixing vessel of claim 1, wherein the container's blade guides the container-shaped inner liner into a correct position by engaging with a triangular portion of a recessed blade of an outer wall of the container-shaped inner liner.

8. The mixing vessel of claim 1, wherein the container-shaped inner liner including a blade having a vertical portion, a triangular portion, and a horizontal portion, wherein the blade extends from an inner wall of the container-shaped inner liner and is recessed on an outer wall of the container-shaped inner liner.

9. The mixing vessel of claim 1, wherein the blades of the mixing vessel facilitate decreasing particle size and mitigate adherence of mixing vessel contents to mixing vessel walls.

10. The mixing vessel of claim 1, wherein the plurality of guides are bounded by a rim that encompasses the exterior side wall of the container between the first and second ends of the container, and wherein the plurality of guides engage with locking elements of a cup-like receptacle on a mixer, securing the mixing vessel in a fixed position relative to the mixer's receptacle during a mixing process, wherein the mixing vessel coordinates movement with the mixer's receptacle.

11. A mixing vessel comprising:
a container including an open first end and a closed second end, an inner side wall of the container defining a cavity, wherein a blade stems off, at least partially, from the inner side wall of the container, and at least partially from a bottom wall of the container, a portion of the blade from the inner side wall and a portion of the blade from the bottom wall merging with each other, wherein a plurality of guides stem from an exterior side wall of the container, the plurality of guides being arranged a pre-determined distance apart and extending around the circumference of the exterior side wall of the container; and
a removable cap configured to close the open first end of the container.

12. The mixing vessel of claim 11, wherein the plurality of guides are bounded by a rim that encompasses the exterior side wall of the container between the first and second ends of the container.

13. The mixing vessel of claim 11, wherein the container is configured in a volume capacity from a group consisting of: 100 milliliters (mLs), 300 mLs, 500 mLs, 600 mLs, 1000 mLs, 1500 mLs, 2000 mLs, 5000 mLs, and 10,000 mLs.

14. The mixing vessel of claim 11, wherein the container is configured with an aspect ratio in a range from 0.5:1 to 2:1.

15. A method for preparing gel, cream, ointment, or powdery compound mixtures within a centrifugal mixer's mixing vessel, the method comprising:
a) aligning and sliding a recessed external wall of a container-shaped inner liner over an inner wall of a container configured with an open first end, a closed second end, and at least one blade, the container restricting axial rotation of the container-shaped inner liner when in an engaged position, and the blade on the container and an internal blade on the container-shaped inner liner being complementary, allowing the container-shaped inner liner to slide into a cavity of the container, where the container-shaped inner liner remains in an engaged position during filling and mixing processes;
b) placing ingredients into a cavity of the container-shaped inner liner having the internal blade;
c) attaching a removable cap to the open first end of the container; and
d) using a centrifugal mixer to induce asymmetric mixing in the mixing vessel by selecting from a formulary of predetermined mixing parameters or establishing new parameters for constituents within the mixing vessel.

16. The method of claim 15, wherein the container is configured in a volume capacity from a group consisting of: 100 milliliters (mLs), 300 mLs, 500 mLs, 600 mLs, 1000 mLs, 1500 mLs, 2000 mLs, 5000 mLs, and 10,000 mLs.

17. The method of claim 15, wherein the container is configured with an aspect ratio in a range from 0.5:1 to 2:1.

18. The method of claim 15, wherein the container-shaped inner liner including a blade having a vertical portion, a triangular portion, and a horizontal portion, wherein the blade extends from an inner wall of the container-shaped inner liner and is recessed on an outer wall of the container-shaped inner liner.

19. The method of claim 15, wherein the blades of the mixing vessel facilitate decreasing particle size and mitigate adherence of mixing vessel contents to mixing vessel walls.

20. A method for mixing gummies, troche, or suppository polyethylene glycol (PEG) and fatty acid bases used for compounding custom formulations targeting various ailments through oral, buccal, or vaginal sub-mucosal administration within a centrifugal mixer's mixing vessel, the method comprising:
a) aligning and sliding a recessed external wall of a container-shaped inner liner over an inner wall of a container configured with an open first end, a closed second end, and at least one blade, the container restricting axial rotation of the container-shaped inner liner when in an engaged position, and the blade on the container and an internal blade on the container-shaped inner liner being complementary, allowing the container-shaped inner liner to slide into a cavity of the container, where the container-shaped inner liner remains in an engaged position during filling and mixing processes, and wherein alignment of the container's blade with a recessed area of the internal blade on the container-shaped inner liner restricts axial rotation of the inner container-shaped inner liner;
b) placing gum base, troche or suppository PEG (polyethylene glycol), fatty acid (oleaginous) base, or a similar composition into a cavity of the container-shaped inner liner having the internal blade;
c) attaching a removable cap to the open first end of the container;
d) using a centrifugal mixer to induce asymmetric mixing in the mixing vessel, following established industry-standard mixing parameters or creating new parameters, wherein the composition may transition from solid to liquid, influenced by a mixing time and a speed of asymmetric mixing;
e) removing the mixing vessel from the mixer after a specified time or once the composition becomes flowable; and
f) detaching the mixing vessel from the mixer and transferring the flowable composition to a suppository or troche mold tray, or another forming tray, wherein the flowable composition is uniformly distributed across multiple identical volume cavities and allowed to cool, forming solidified troches, suppositories, or gummies.
